(19) United States
(12) Patent Application Publication
(10) Pub. No.: US 2019/0011058 A1
(43) Pub. Date: Jan. 10, 2019

(54) Electric Coils

(71) Applicant: Anthony Freakes, Lawrenceville, NJ (US)

(72) Inventor: Anthony Freakes, Lawrenceville, NJ (US)

(21) Appl. No.: 16/111,708

(22) Filed: Aug. 24, 2018

Related U.S. Application Data
(62) Division of application No. 14/812,467, filed on Jul. 29, 2015.
(60) Provisional application No. 62/030,169, filed on Jul. 29, 2014.

(51) Int. Cl. F16K 31/06; H01F 41/12; H01F 41/04; H01F 27/32; H01F 5/06; H01F 5/00; B05B 1/34; B05B 1/30; B05B 15/60

(52) U.S. Cl. CPC F16K 31/0675; H01F 41/122; H01F 41/043; H01F 27/324; B05B 15/60; H01F 5/003; F16K 31/0658; B05B 1/3405; B05B 1/3053; H01F 5/06

(57) ABSTRACT

Conductor coils which induce a magnetic field and methods of making same are disclosed, the conductor coil having at least one layer of conductive material formed in a spiral, the spiral having an inner portion forming an air core. Also disclosed are conductor coils and methods of making same having at least two spiral layers of conductive material, wherein the first spiral layer has a configuration in which a first end terminates at an exterior periphery of the first spiral layer and extends spirally inward toward an inner portion of the first spiral layer and terminates at a second end, wherein the second spiral layer has a configuration in which a first end terminates at an interior periphery of the first spiral layer and extends spirally outward toward an exterior periphery of the first spiral layer, wherein the second spiral layer first end is conductively connected to the first spiral layer second end.

### CROSS-REFERENCE TO RELATED APPLICATIONS

This application is a divisional of U.S. patent application Ser. No. 14/812,467 filed Jul. 29, 2015, which claims the benefit of U.S. Provisional Patent Application No. 62/030,169 filed Jul. 29, 2014, the entireties of which are incorporated herein by reference.

### FIELD OF THE INVENTION

The invention relates to electric coils and methods of making electric coils.

### BACKGROUND

For over 100 years, electric coils have been constructed using wire coated with insulation, usually termed “magnet wire”. This wire is wound onto bobbins to achieve the various benefits of coils. The number of solenoids, motors, transformers, inductors, etc. in use every day is enormous.

### SUMMARY OF THE INVENTION

Electric coils are disclosed herein which do not require a magnet wire. Spiral conductors are disclosed which provide a coil producing a magnetic flux. The spiral conductors disclosed herein may include only a single spiral conductor layer, or plural layers. The spiral conductors may be circular, square, rectangular or any other suitable shape. The spiral conductor layer or layers include(s) a central air core to accommodate a solid core, plunger and/or other element depending on the application.

Traditional coils are made by starting near the center and making a complete coil, with subsequent coils outside the first coil. Such traditional coils are fixed and not flexible. The presently disclosed methods provide an end-to-end method in which the conductor may be spiral and as desired for a particular application, subsequent layers of spirals are built lengthwise. The spiral method disclosed herein provides a flexible coil that may be built out to any desired length. Coils as described and used herein may also be helical, overlapping rings, etc. Methods are also provided for making electric coils without a magnet wire. The devices and methods disclosed herein not only eliminate the need for winding, but also eliminate the costs associated with making magnet wire. A tremendous amount of work is involved in making a fine wire, including the gradual drawing down from larger originally-cast rod, reduction by reduction (about 20% per reduction), subsequent annealing of the copper after the copper is work-hardened and then further reduction, using big machinery occupying a lot of space. Even then, when the wire is finally at the size required, it has to be coated with insulating lacquer. The presently disclosed methods and devices eliminate all of these steps and the associated expense.

In accordance with some embodiments, a magnetic flux-inducing conductor may be formed into a spiral or other shape with suitable air spacing and molding an insulating structure around the conductor. The spiral magnetic flux-inducing conductor may be square, rectangular or other shape depending on the application. The conductor may be a single spiral layer or a plurality of stacked spiral layers. It is possible to make such a conductor when the size of the conductor makes it rigid enough to support its own weight. The magnetic flux-inducing conductor may be made using for example a 3-D printer, computer numerical control (CNC) machines such as mills, lathes, plasma cutters, electric discharge machining (EDM), water jet cutters, laser cutting, etc. A mold may be employed to support the conductor, wherein melted insulator material such as plastic is used to fill the mold to occupy the air space and insulate the conductor. It will be apparent that the process of insulating the conductor is intended to coat the conductor and the air spaces while leaving the air core open.

In accordance with other embodiments, methods are disclosed for making coils producing a magnetic flux which involve forming an insulation body, for example a single piece of insulating material of the type typically used to coat a wire to form a magnet wire, with a cavity, which cavity is formed for the purpose of receiving conductor material. In one embodiment, 3-dimensional (3D) printers and 3D printing techniques may be employed to produce a single or multi-layer insulator body having a cavity or groove that can be filled with conductive material to form a flux inducing coil. Laser cutting techniques may also be used. Coils as described and used herein may be helical, spiral, overlapping rings, etc.

In embodiments in which a conductive material is introduced to a cavity or groove formed in an insulator, a conductor material may include any suitable material such as a powder, granulate, liquid or any form which lends itself to filling into a cavity. The material may be tamped or otherwise settled using various techniques such as vibration until the desired level of compactness is achieved. The material may be introduced via suction, pressure or the like, and filtered if desired. The ends of the cavity may be sealed. Connectors such as brass connectors or the like positioned at the ends of the coils may likewise be filled and soldered. In another embodiment, a lead wire may be joined directly to the filler material, obviating the need for a connector. The composition of the material used to fill the cavity may be selected to provide desired coil properties depending on the application.

In some embodiments a conductor coil which induces a magnetic field includes at least one layer of conductive material formed in a spiral, the spiral having an inner portion forming an air core.

In some embodiments conductor coils are disclosed including at least two spiral layers of conductive material wherein the first spiral layer has a configuration in which a first end terminates at an exterior periphery of the first spiral layer and extends spirally inward toward an inner portion of the first spiral layer terminating at a second end, wherein the second spiral layer has a configuration in which a first end terminates at an interior periphery of the first spiral layer and extends spirally outward toward an exterior periphery of the first spiral layer, wherein the second spiral layer first end is conductively connected to the first spiral layer second end. The conductor coils are magnetic flux-inducing. The conductor coils may include plural spiral layers. At least one of the spiral layers is generally planar in cross-section. In some embodiments all of the spiral layers are generally planar in cross-section as shown in the accompanying FIGs.

Successive spiral layers of the conductor coil are connected by at least one bridge. The successive spirals may have the same or different number of turns. The spiral layers may have the same or different radii, and the pitch of the conductors may be the same or different as between successive layers. The spiral layers may be configured to extend spirally clockwise or counterclockwise, but either way, typically extend in the same direction.

The conductor coil may include in some embodiments a power connector extending from at least one of the spiral layers. The conductor coil may include an insulation layer coating the conductor coil and filling air spaces defined by the conductor coil.

In one embodiment a methods of making a conductor coil as described above may include simply forming a first spiral layer and connecting the first spiral layer to one or more successive spiral layers.

In another embodiment a method of making a conductor coil as described above may involve providing a mold having a configuration corresponding to a conductor coil as described above, filling the mold with conductive material, and casting the conductor coil from a conductive material in the mold.

In still a further embodiment a method of making a conductor coil as described above involves constructing an insulation body having an internal cavity having a configuration corresponding to the configuration of the conductor coil described above and introducing conductive material into the insulation body. The step of constructing the insulation body having an internal cavity may include printing the insulation body with an internal cavity using a three-dimensional printer. The method may involve forming plural layers of insulation material having spiral grooves, each of the grooves having at least one aperture formed therein, superimposing the plural layers such that the respective grooves of adjacent layers are configured to form a continuous cavity corresponding to the configuration of the conductor coil and the at least one aperture of each of the grooves is in communication with an a groove of an adjacent layer.

In other embodiments, the method involves forming a spiral groove on a first insulation layer, the spiral groove having an aperture, filling the groove with a conductor material such that a first spiral layer is formed and a first bridge of conductive material is formed in the aperture, superimposing a further insulation layer comprising a spiral groove formed therein and an aperture formed in the groove, and filling the groove with a conductor material such that the conductive material forms a second spiral layer and a conductive connection with the first bridge and forms a second bridge that may be conductively connected to a subsequent spiral layer. Successive spiral layers may be added as needed for a particular application.

In other embodiments an insulation body includes an opening formed therein and a continuous spiral groove formed in the insulation body along an outer perimeter of the opening. The opening may provide the region defining an air core of a conductor coil.

In other embodiments, an insulation body is provided having an internal cavity with a continuous cavity having at least two spiral layers wherein the first spiral layer has a configuration including a first end terminating at an exterior periphery of the first spiral layer and extending spirally inward toward an inner portion of the first spiral layer terminating at a second end, wherein the second spiral layer has a configuration having a first end terminating at an interior periphery of the first spiral layer and extending spirally outward toward an exterior periphery of the first spiral layer, wherein the second spiral layer first end is in open communication with the first spiral layer second end. The insulation body may include a central bore. A sidewall of the central bore may include an aperture formed therein to receive conductive material.

In still further embodiments, solenoids having a conductor coil as described above are disclosed herein.

In yet still further embodiments, an atomizer system having a solenoid employing a conductor coil as described above are disclosed, the system having a valve operably connected to the solenoid, wherein the valve is operably connectable to a fluid supply and a spray orifice.

In another embodiment, a solenoid is disclosed having a plunger with a flange configured and operable to remove air gaps and obtain intimate contact between elements of a magnetic circuit of the solenoid. The solenoid may include a return spring operable to serve as a shading ring, wherein the return spring is positioned between the flange of the plunger and a magnetic circuit pot of the solenoid.

In addition to the other advantages listed above, a major advantage of the presently disclosed magnetic flux inducing conductor coils is that the magnetic flux concentration can be controlled and adjusted. For, example normal wound coils have a concentration of magnetic flux at the center of their length. This is why the usual juncture of core to plunger is positioned at the center of their length. By contrast, the number of turns of each conductor layer, conductor thickness, and insulation thickness of the presently disclosed embodiments can all be varied to locate the higher concentration of flux at a different point than the center. This enables lighter weight, faster moving plungers in solenoids and increases the speed of operation.

### BRIEF DESCRIPTION OF THE DRAWINGS

For the purposes of illustration, there are forms shown in the drawings that are presently preferred, it being understood, however, that the invention is not limited to the precise arrangements and instrumentalities shown.

FIG. 1 is a perspective view of a conductor coil layer which spirally progresses from an outer starting end towards the inner end of the spiral layer in accordance with one or more embodiments of the present invention;

FIG. 1A is a perspective view of a plurality of coils of the type shown in FIG. 1, forming a larger coil consisting of as many basic coils as is required for a particular application in accordance with one or more embodiments of the present invention;

FIG. 2 is a perspective view of the outer appearance of a molded insulation body in accordance with one or more embodiments of the present invention;

FIG. 3 is a top perspective view of a an insulation layer including a spiral groove formed thereon in accordance with one or more embodiments of the present invention;

FIG. 4 is a top perspective view of an insulation layer according to FIG. 3 wherein the groove is filled with conductor material in accordance with one or more embodiments of the present invention;

FIG. 5 is a top perspective view of an assembly of two insulation layers with conductor material contained therein wherein the layers have the equivalent electrical path of the conductor shown in FIG. 1 in accordance with one or more embodiments of the present invention;

FIG. 5A is a perspective view of an assembly of plural insulation/conducting layers, which have the equivalent electrical path of the conductor shown in FIG. 1A in accordance with one or more embodiments of the present invention;

FIG. 5B is a perspective view of an assembly of plural insulation/conducting layers, in accordance with one or more embodiments of the present invention;

FIG. 6 is a schematic view of a system for filling an insulator body in accordance with one or more embodiments of the present invention;

FIG. 7 is a diagrammatic view of motor rotor having an insulator body in accordance with one or more embodiments of the present invention;

FIG. 8 is a side cross-sectional view of an insulator body and connector in accordance with one or more embodiments of the present invention;

FIG. 9 is an end view of a solenoid in accordance with one or more embodiments of the present invention;

FIG. 9A is a cross-sectional view of the solenoid of FIG. 9 taken along line A-A′;

FIG. 10 is a side view of a solenoid body in accordance with one or more embodiments of the present invention;

FIG. 10A is a cross-sectional view of the solenoid of FIG. 10 taken along line B-B′;

FIG. 11 is a perspective view of an insulating body of a solenoid in accordance with one or more embodiments of the present invention;

FIG. 12 is top view of an atomization apparatus employing a solenoid in accordance with one or more embodiments of the present invention;

FIG. 12A is a side view of the apparatus of FIG. 12;

FIG. 12B is a side view of the apparatus of FIG. 12;

FIG. 12C is a cross-sectional view of an apparatus according to FIG. 12 taken along line C-C′ in accordance with one or more embodiments of the present invention;

FIG. 12D is a cross-sectional view of a solenoid according to FIG. 12 in accordance with one or more embodiments of the present invention;

FIG. 13 is a cross-sectional view of a solenoid in accordance with one or more embodiments of the present invention;

FIG. 13A is a cross-sectional view of the solenoid of FIG. 13 in accordance with one or more embodiments of the present invention;

FIG. 14 is a top perspective view of an insulation layer including a spiral groove formed thereon in accordance with one or more embodiments of the present invention; and

FIG. 15 is an exploded perspective view of a motor employing spiral coils in accordance with one or more embodiments of the present invention.

### DETAILED DESCRIPTION OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The phrase “magnet wire” as defined and used herein refers to a wire coated with insulation.

Electric coils are described herein which do not require a magnet wire. Spiral conductors are disclosed which provide a coil producing a magnetic flux. Such coils may be employed in devices such as solenoids, motors, transformers, inductors, etc. Various methods of making such coils are disclosed herein.

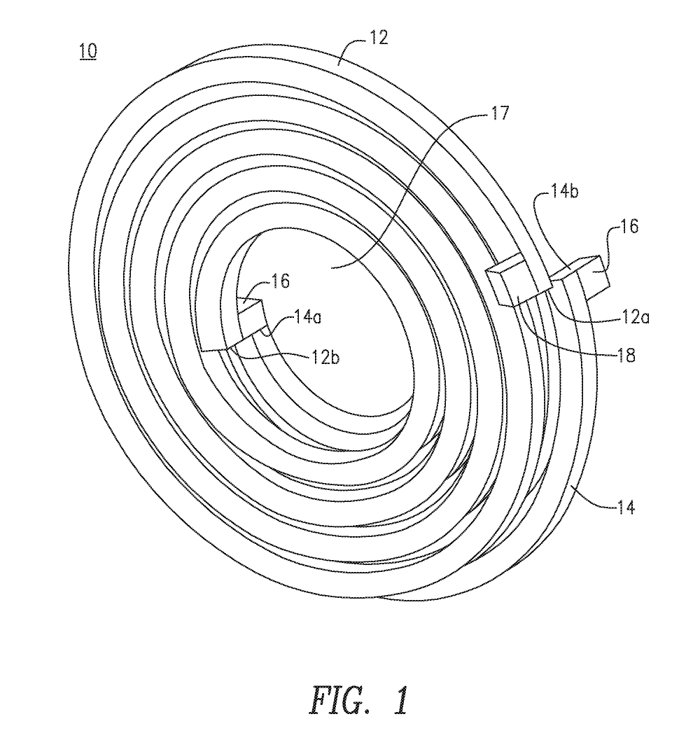

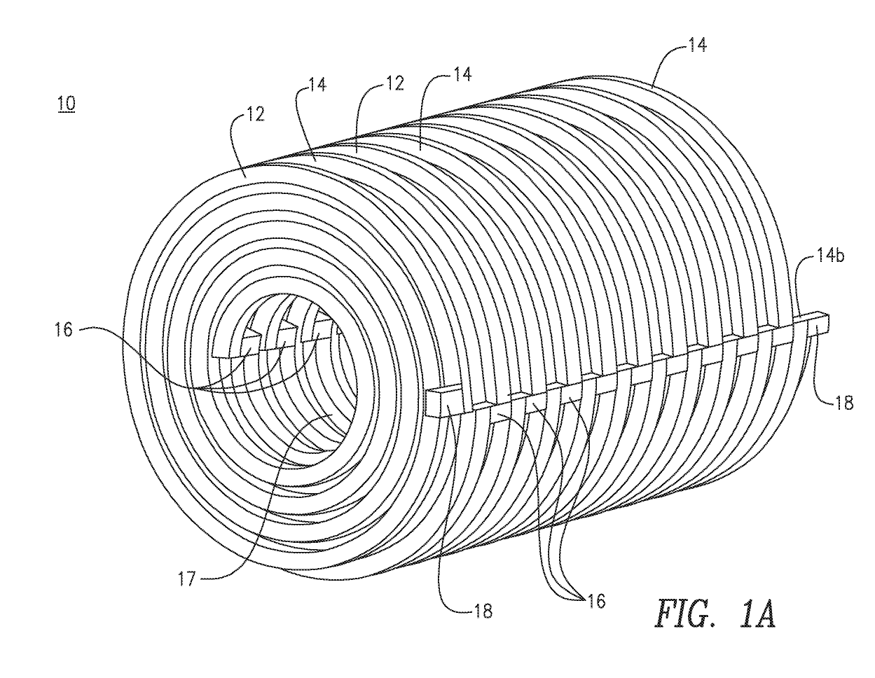

With reference to FIG. 1, a solid conductor 10 includes a plurality of spiral layers 12 and 14 each having an air core 17, the layers connected via bridges 16. Spiral layer 12 is configured to spirally progress from an outer starting end 12a toward the inner end 12b, where it connects to a successive spiral layer 14 via bridge 16. Spiral layer 14 spirals outward from inner end 14a to outer end 14b the same number of turns as spiral layer 12. Bridge 16 extends from end 14b to connect to a successive layer. The spiral direction of spiral layers 12 and 14 are both counterclockwise as shown, but one skilled in the art will recognize the direction could be clockwise. Solid conductor 10 thus constitutes a pair of spirals which forms a coil in which the conductor is insulated by the air spaces. If a low electric current were to flow through this coil, a similarly low magnetic flux would be generated. Power connector 18 may be formed on end 12a.

With reference to FIG. 1A, multiple spiral layers 12 and 14 form a single coiled air conductor 10 including as many basic coils as shown in FIG. 1 as may be required. Bridges 16 connect successive spiral layers. The last spiral layer 14 may include a further power connector 18 extending from end 14b.

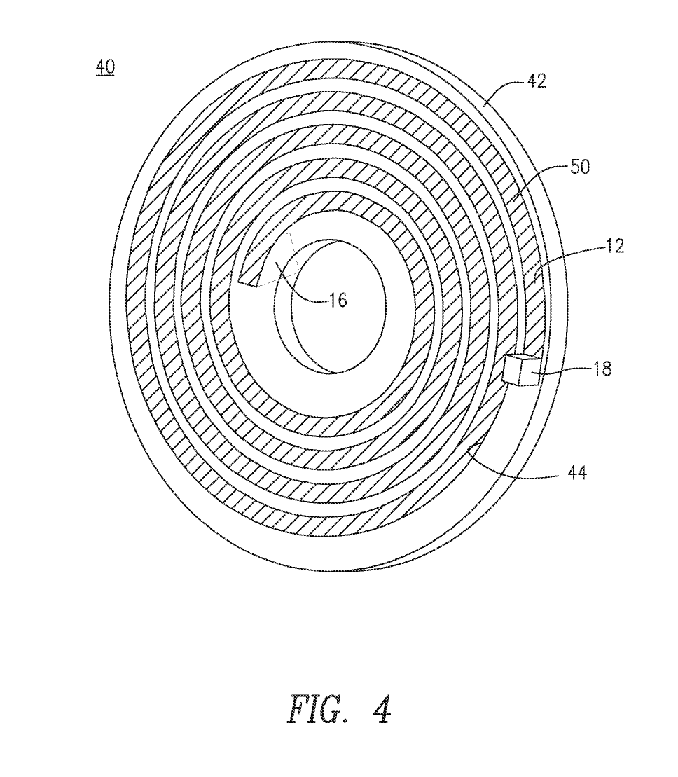

An example of a single-layer magnetic flux-inducing spiral coil is shown in FIG. 4 as further detailed below.

The cross-section of the conductor 10 may be any suitable dimension and shape. For example, and not by way of limitation, in one embodiment the largest cross sectional diameter of the conductor is in the range of 0.001 mm to 10 mm. In another embodiment the largest cross sectional diameter of the conductor is in the range of about 0.05 mm to about 8 mm. In another embodiment the largest cross sectional diameter of the conductor is from about 0.1 mm to about 0.5 mm. In another embodiment the largest cross sectional diameter of the conductor is about 0.2 mm. In one embodiment the conductor includes a square cross section having dimensions on one side of about 0.001 mm to about 10 mm and on another side of about 0.001 mm to about 10 mm. In one embodiment the dimensions are 0.2 mm×0.2 mm.

The foregoing figures and description can be applied by using prior art manufacturing methods such as metal die casting, metal stamping and automatic assembly etc.

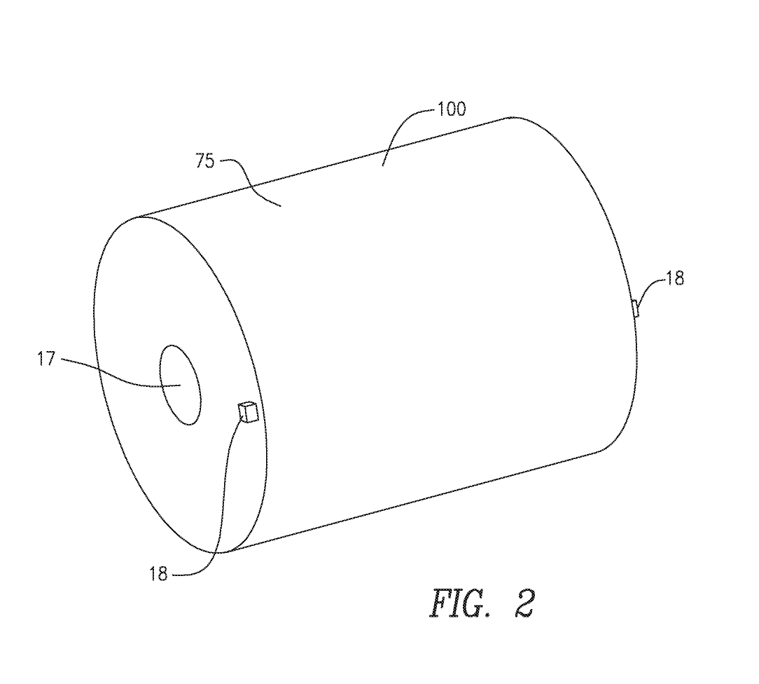

Now referring to FIG. 2, an insulated conductor 100 includes insulation coating 75. The insulation coating 75 may be molded onto conductor such as the conductor 10 shown in FIG. 1A by placing conductor 10 in a mold and introducing a molten insulating material into the mold. The molten material flows wherever there is space and displaces the air which was between the turns of conductor 10. This provides greater insulation, and allows a higher electrical current to flow through the conductor and therefore results in a higher magnetic flux. Power connectors 18 extending from the insulated conductor 100 may be stripped of insulating material 75 if, and as, necessary.

Another method for making a conductor coil, such as a solenoid coil, is disclosed in which the insulation is a solid body with an internal cavity. The solid body insulator can be built using a 3D printer or other methods such as laser cutting, CNC, etc. 3-dimensional (3D) printers are used to print thin layers of computer-controlled deposits of various materials and build these layers into solid three dimensional objects. By using various available materials, this technique can be employed to build assemblies. The cavity may be formed by the superposition of multiple printed layers of insulation material. In some embodiments the cavity so formed may be helical, spiral, maze-like, in the form of stacked, off-center circles, or any shape adequate to provide a coil producing a magnetic flux. In some embodiments the cavity includes a long, small cross-sectioned path. Once the cavity is formed, material such as conductive material may be introduced into the cavity to form a coil.

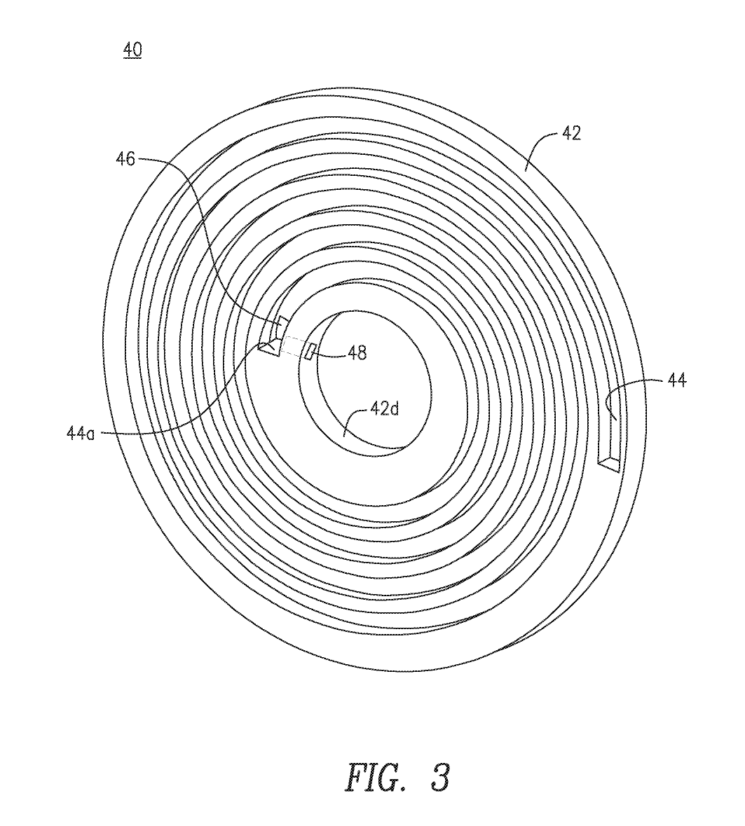

Now referring to FIG. 3, an insulation body 40 includes insulation layer 42 with a spiral groove 44 formed in a face thereof. An aperture 46 may be formed at an inner end 44a of groove 44 to formation an open communication between successive insulation layers. When conductive material is introduced into the groove 44, conductor material will form a bridge 16 as shown in FIG. 1. In some embodiments, a fill aperture 48 may be formed along interior surface 42d in communication with groove 44 to permit filling of conductive material when multiple layers of insulation are formed prior to introduction of conductive material. The insulation body 40, and layer 42, may be produced for example using a 3D printer.

The thickness of walls between grooves is from about 0.001 mm to about 8 mm. The same range applies to the wall thickness between adjacent layers.

Now referring to FIG. 4, groove 44 of the insulation layer 42 is filled with conducting material 50 forming an outward-to-inward counterclockwise spiral conductor layer 12 as shown in FIGS. 1 and 2. This material may be a solid and be simply assembled, or a powder which is tamped, or a conducting liquid, filling the groove with conductor. Other methods of filling the groove will be apparent to those skilled in the art.

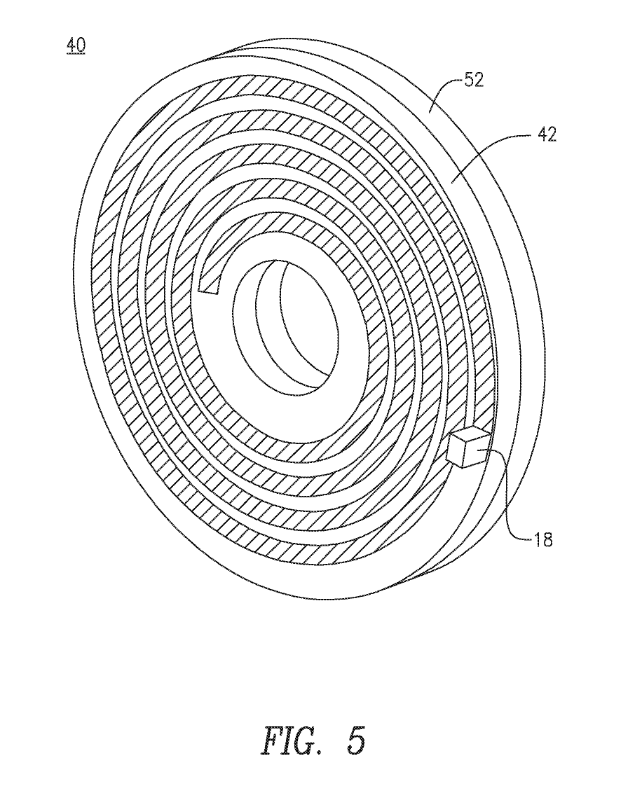

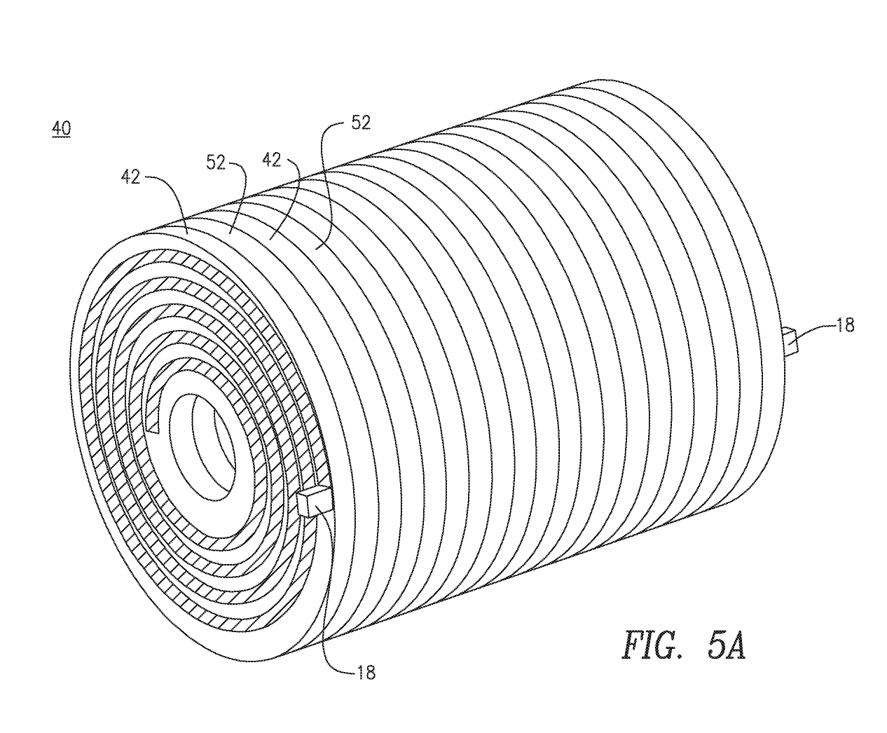

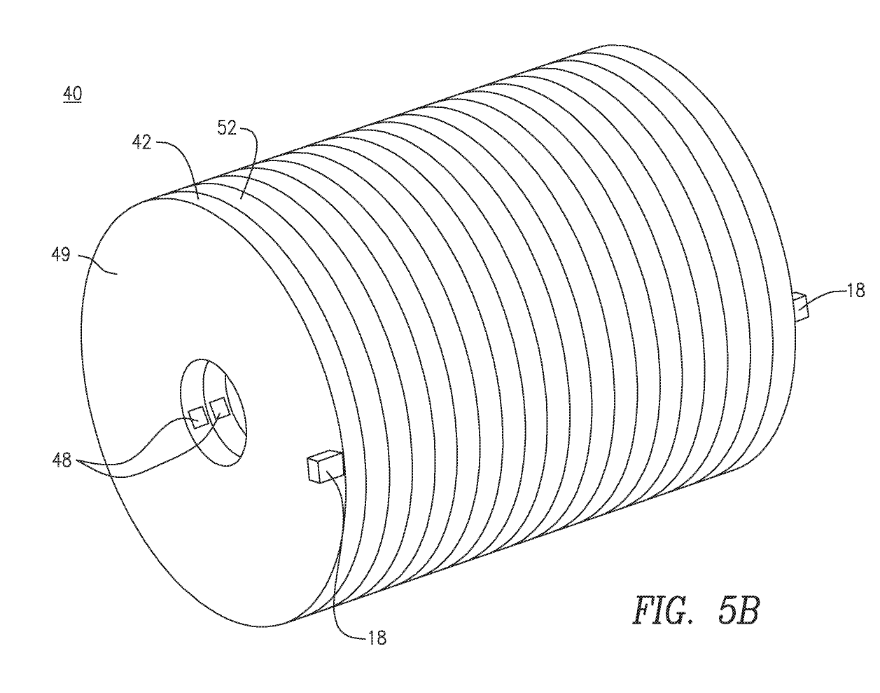

Now referring to FIG. 5, assembly 40 shows two insulation layers 42 and 52. Layer 52 includes a groove (not shown) which when filled with conductor material includes spiral conductor layer 14 (FIG. 1) which spirals from inner end 14a to outer end 14b the same number of turns as spiral conductor layer 12. Bridge 16 connects spiral conductor layers 12, 14.

With reference to FIGS. 5A and 5B, an insulation body 40 formed of plural printed layers 42 and 52 is shown. Multiple layers 42, 52 produced such as for example by a 3D printer may be stacked to any height desired. Other methods may be employed as well. For example, layers of insulating sheets may be laser cut to represent the desired winding pattern, and the layers assembled to build an insulation solid body having an interior cavity.

FIG. 5A shows a complete coil without an end cap or fill apertures. The embodiment of FIG. 5A may be produced with conductor material added layer by layer as successive layers of insulation are built. An end cap 49 may be added upon completion of fabricating the insulation body 40. The embodiment of FIG. 5B, which shows an end cap 49 and fill apertures 48, may be employed in embodiments in which conductor may be added after fabrication of the insulation body 40. Each fill aperture 48 may for example fill two spiral layers until the whole insulator body 40 is filled. End cap 49 may be fabricated as part of the overall insulation body or added to the insulation body separately. Fill apertures 48 may be sealed after filling operations.

It will be recognized by those skilled in the art that the methods of inserting the conducting material may be selected to suit the application and the complexity of the coil. These methods could utilize for example pressure and vacuum, gravity, centrifugal force, etc. The insertion of the conductor could be via a single point or multiple points.

It is expected that further developments in 3D printing of metals will enable a practical construction of the entire coil, including the insulation, the conducting coil and the power connecting points.

The finished conductor coil can be tested for continuity by any means known in the art.

It will be recognized by those skilled in the art the foregoing assemblies and devices can be produced using known methods such as plastic molding, die casting, stamping, automatic assembly, etc.

Any suitable material may be employed to fill the insulator body 40. Conductive materials such as copper, silver, etc. may be used to fill the cavity. The conductive material may be provided in solid, powdered form or in liquid form. When the grooves or internal cavity (as the case may be, depending on the method of incorporating the conductor material and the structure) of the insulator body 40 are/is filled with an electrically conductive material, it becomes a magnetic flux-causing coil. One of the advantages of coil structures made in accordance with the present disclosure using powdered or liquid conductive materials to fill pre-formed cavities/grooves is that it is easy to change the resistance simply by mixing the conductive filling material with a material having a higher or lower conductivity. For example, copper filling material may be mixed with a less conductive material such as but not limited to carbon, or a more conductive material such as silver. Adjusting the conductivity of the filling material as described enables one to change the current, power and temperature without changing the coil structure, configuration, and/or physical shape.

In addition, low melting metals and/or fusible alloys can be mixed with conductive powder such as copper powder to make rigid coil structures. Examples of such low melting metals/alloys include mercury-containing alloys, alkali metal-containing alloys, gallium-containing alloys, and alloys containing bismuth, lead, tin, cadmium, zinc, indium, or thallium. In some embodiments the low melting metal may be Wood's metal, Field's metal, Rose metal, or Galinstan.

The filling of the cavity can be accomplished in one embodiment by introducing a finely powdered conductor, such as copper, or a conductive fluid, and upon completion of the filling, joining the ends of the cavity to solid connectors to make power connection easy. This process may be enhanced by pressurizing the powder going into the cavity and vacuuming the powder coming out of the cavity, and using vibration and jerky orientation changes, until the cavity is solidly filled. Insulated coils formed in accordance with the methods disclosed herein eliminate the need for winding magnet wire.

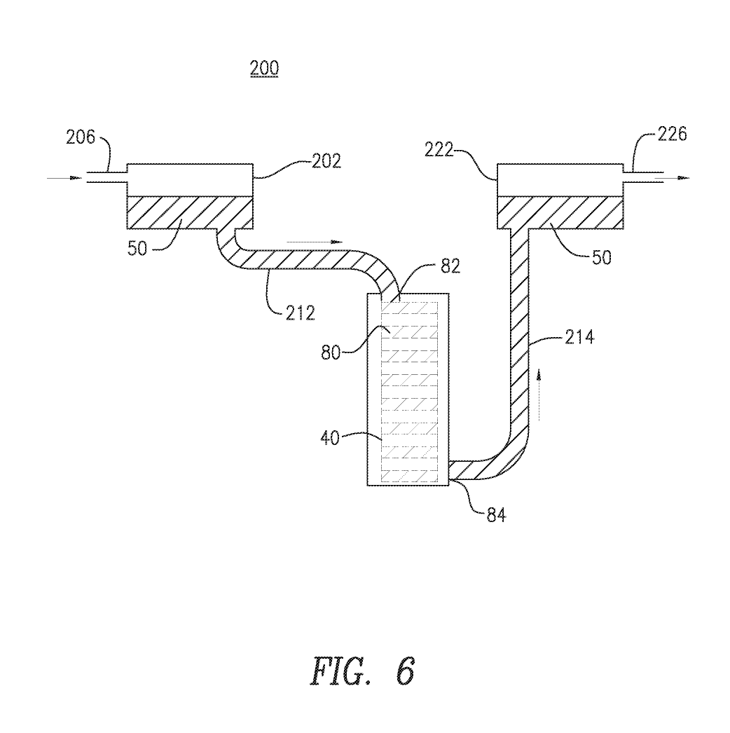

Now referring to FIG. 6, in one embodiment a method of filling the cavity 80 of an insulator body 40 may employ a system 200 including a material reservoir 202 fluidly connected via a conduit 212 to a cavity opening 82 of an insulator body 40 and a vacuum operably connected to an opening at an opposite end 84 of the cavity of the insulator solid body. Pressure applied to the reservoir 202 via inlet 206 forces conductor material 50 (such as powder or fluid) from the reservoir 202 into the cavity 80 while vacuum applied via outlet 226 and conduit 212 at the cavity end 84 opposite the cavity opening draws the material into the cavity 80. One or more filters may be employed between the reservoir 202 and the cavity opening 82 to remove impurities, control particle size, etc. Material drawn fully through the cavity 80 may be received in a collection vessel 222. Material can be recycled from the collection vessel 222 to the reservoir 202. Conductor material 50 not passed completely through the cavity 80 is deposited in the cavity 80 until the cavity is filled. Tamping, jerky orientation and/or vibration can be used to enhance compaction of the material in the insulator body 40. The ends 82, 84 of the cavity 80 may then be sealed.

Regardless of the method employed to fill the insulator cavity, in the case in which a powder filler is employed, it is generally desirable to conduct the filling operation in conditions of low humidity to enhance powder flow. In addition, particle size relative to cavity cross section size will impact filling efficiency. Employing a conductor with higher resistance permits a cavity having a larger cross section to be used, which enhances the ability to fill the cavity.

Now referring to FIG. 7, in accordance with one embodiment, a motor rotor simulator 300 is provided which may serve as a conductive material reservoir. Reservoir(s) 310 for conductive material are located at a base of one or more spokes 302 of the motor rotor simulator 300. The motor rotor simulator simulator 300 may be attached to a insulator body 40. Turning the motor rotor simulator 300 at a high rotational speed forces the conductive material 50 into the cavity or cavities of the insulator body 40 by centrifugal force.

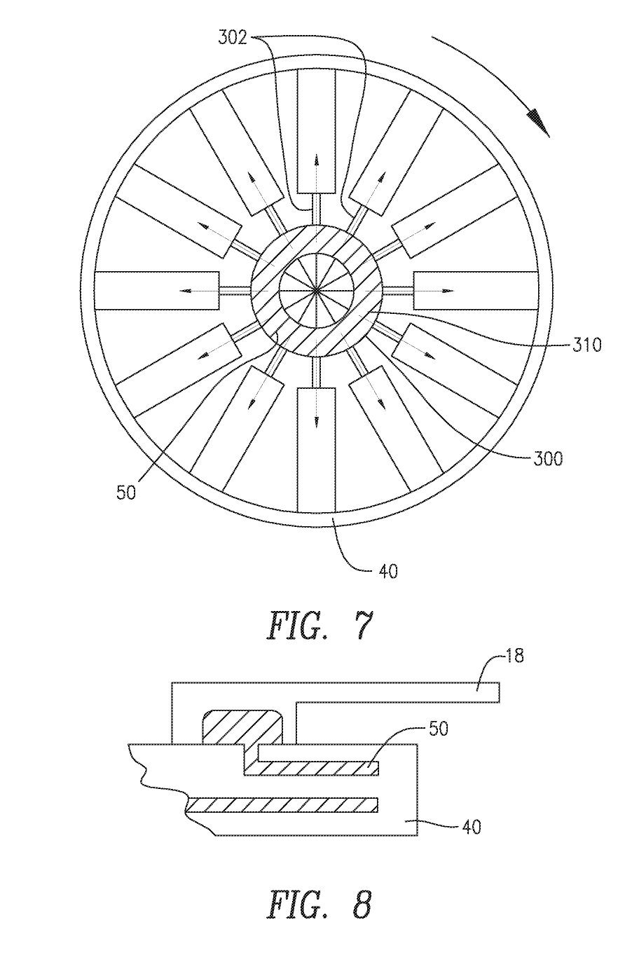

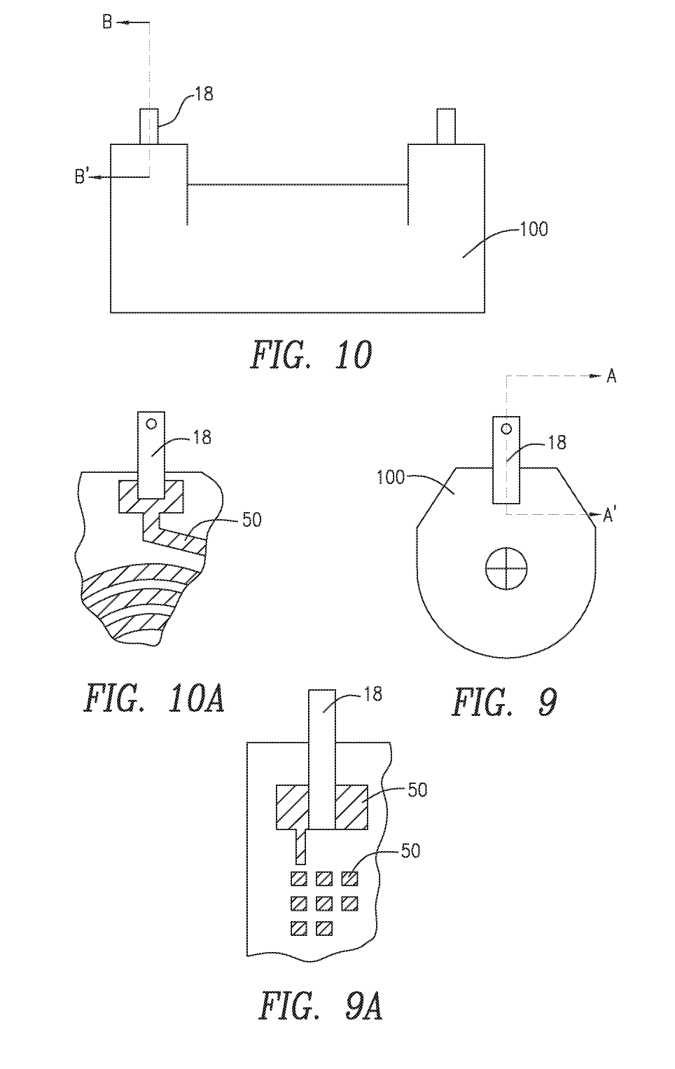

Now referring to FIG. 8, connectors such as connectors 18 may be applied to the insulator 40, such as by pressing the connector 18 into the insulator. Now referring to FIGS. 9-10A, examples of a solenoid 100 are shown with a connector 18 showing various methods of connection.

In some embodiments, a lead wire may be joined directly to the filler material, obviating the need for a connector.

Any suitable insulator material may be employed in connection with the disclosed embodiments, such as but not limited to any non-conductive material such as plastic, ceramic, silk, fiberglass, paper, wood, etc.

In case of electrical conductive material having a melting temperature which is lower than the insulator maximum distortion-free temperature, disclosed are methods which can be utilized to make very reliable coils. There are 3D printable insulator materials which can withstand high temperatures. The following are maximum temperatures of selected common insulator materials:

| | |
|---|---|
| Polyimide | 550° F. |
| Teflon | 500° F. |
| Torcon | 500° F. |
| PFA | 500° F. |
| PEEK | 480° F. |
| PPS | 425° F. |
| FEP | 400° F. |
| silicon rubber | 400-500° F. |
| fluorosilicone rubber | 450° F. |
| Viton fluoroelastomer rubber | 400° F. |

There are metals and metal alloys which melt below some or all of the foregoing temperatures. For example, tin/silver solder melts at 430° F.; tin melts at 450° F.; tin/lead (63%/37%) melts at 361° F., etc. Any metal or alloy having a melting point below the melting point of the selected insulator material may be employed.

It will be apparent to the skilled artisan that low temperature metal alloys may be used if a lower temperature insulating material such as ceramic is desired. In one embodiment, a conductor which melts below 300 F but does not melt when powdered is a desirable fill material. Various such materials are available from Belmont Metals, Inc. of Brooklyn, N.Y., including but not limited to Belmont 2562 Base (MP 255° F.) and 2581 Tru (MP 281° F.).

In one embodiment, a method of making an electric coil includes introducing the conductor material into the cavity as a powder and subsequently subjecting the assembly to heat treatment to melt the conductor, and solidifying the conductor in a cooling step. In another embodiment, a method of making an electric coil includes introducing the conductor material into the cavity in molten form, and solidifying the conductor in a cooling step. In addition, it is expected that once 3D printing equipment and technology is advanced enough to print metals, the coil can be built as an assembly of insulator and conductor layer by layer.

Embodiments of the presently disclosed subject matter provide several advantages. For example, coils made according to the methods are neat and compact. Coils made according to one or more of the methods, when used in motor rotors, minimize unbalance. Regardless of the device in which such coils may be used, the coils can be designed for better cooling. Moreover, in a fixed insulation, the conductor can be a mixture to give a specified resistance. In addition, end terminals can be applied automatically to make power connection easy. A lead wire may be joined directly to the filler material, obviating the need for a connector.

Specialty coils can be made more readily than manual winding. Coils can be changed easily in diameter and length. Also, the conductor cross sectional area and the number of turns can be changed easily.

With advances in 3D printing technology, the presently disclosed methods are expected to yield reduced costs, and the productivity to cost ratio will approach or surpass that of current traditional wire winding operations.

### Examples

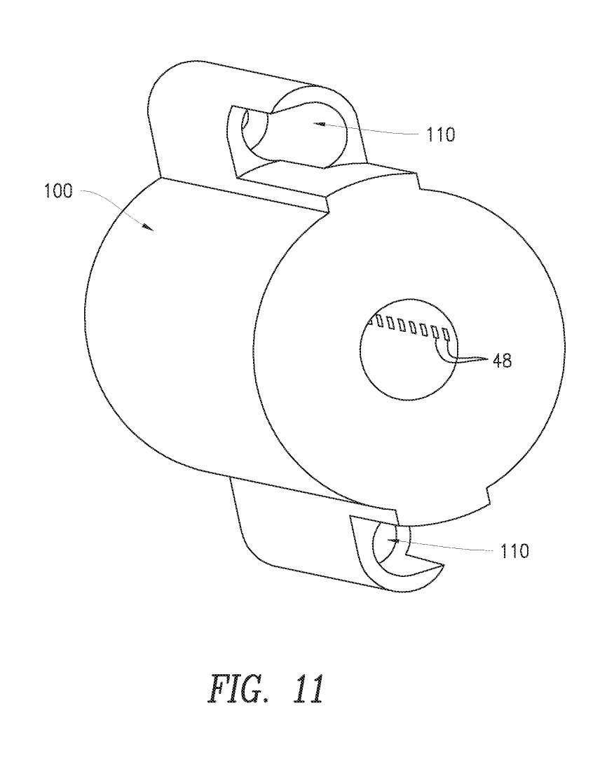

With reference to FIG. 11, a solenoid 100 employing the disclosed subject matter is depicted having pockets 110 to receive lead wires. Filling apertures 48 may be sealed after filling. Optionally, the solenoid 100 is built according to an embodiment not requiring filling, in which case apertures 48 are not required.

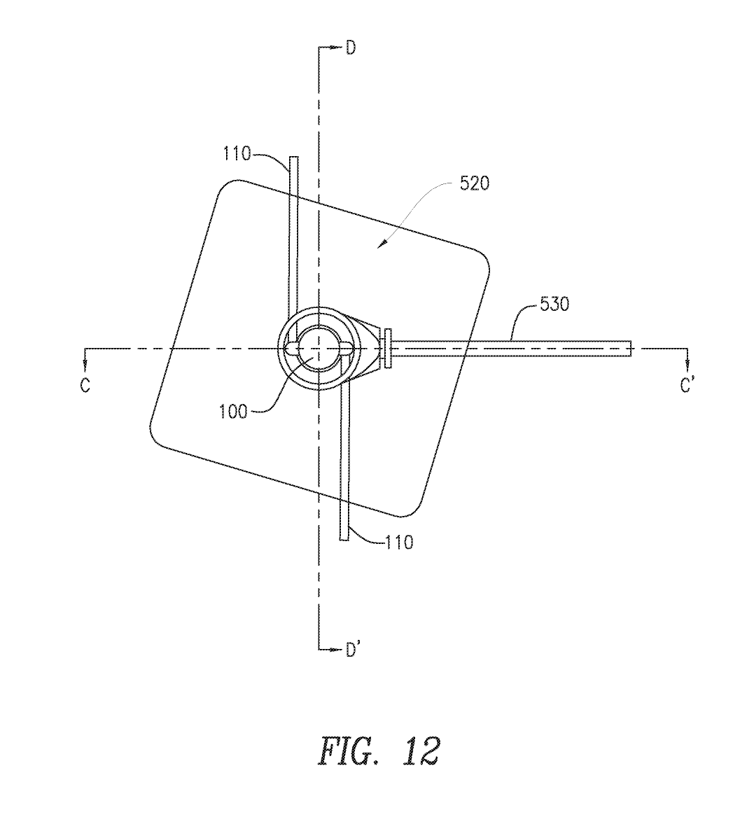

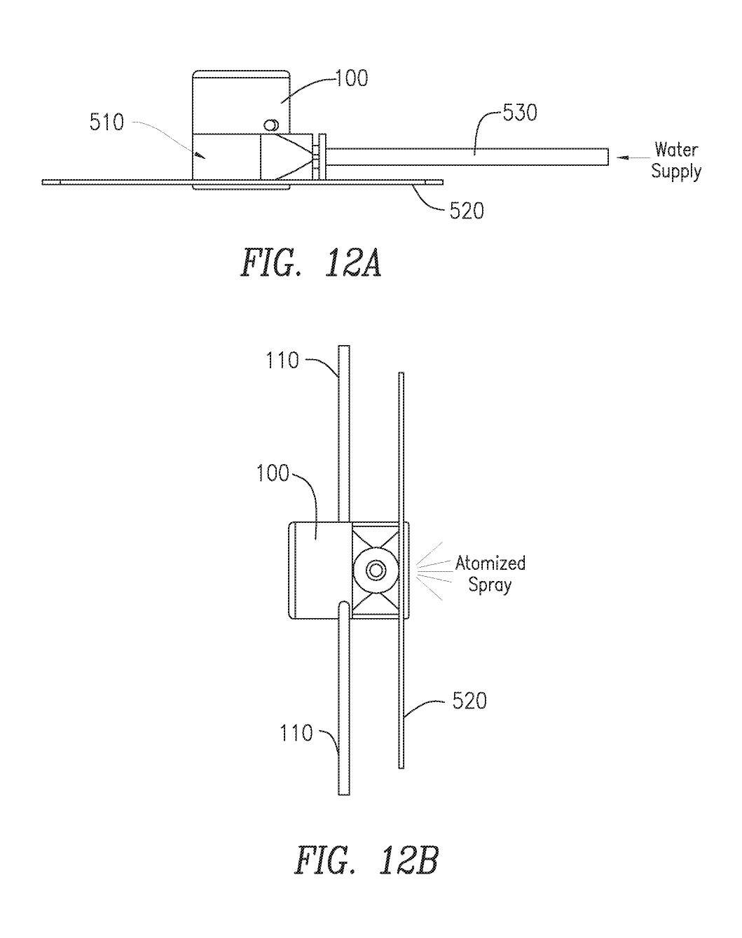

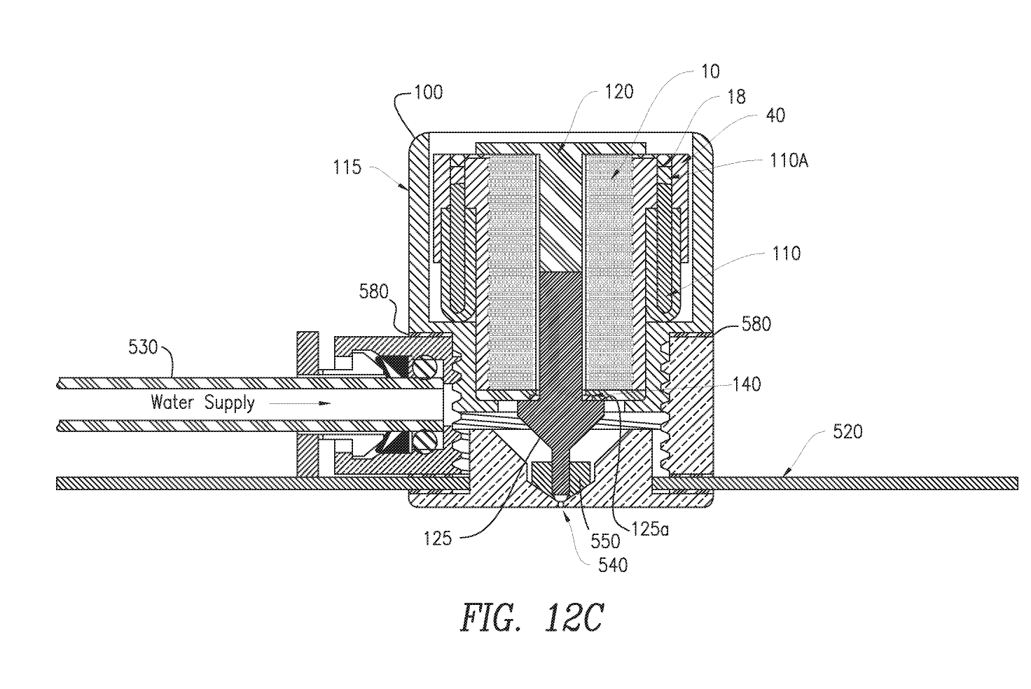

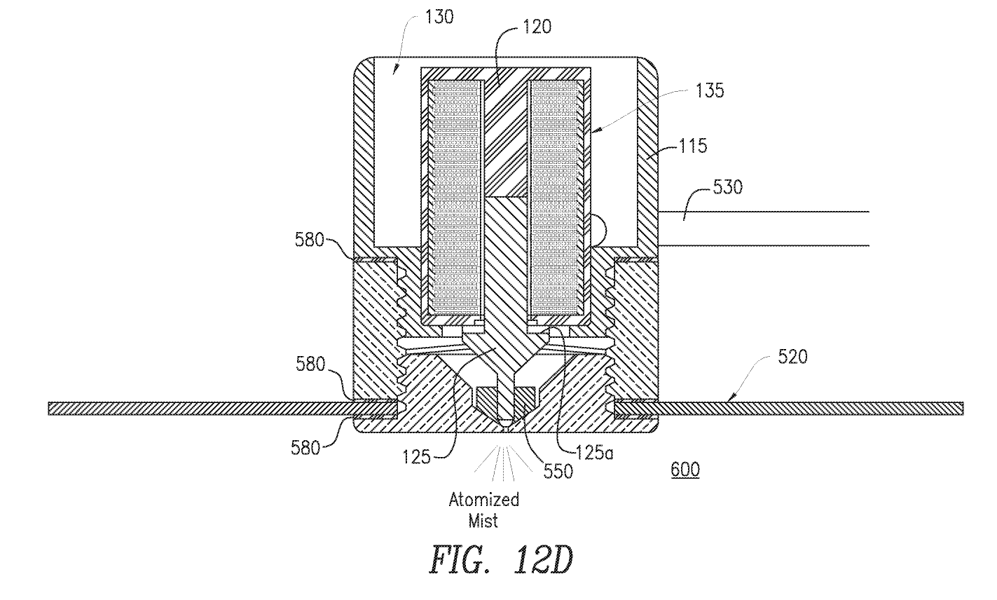

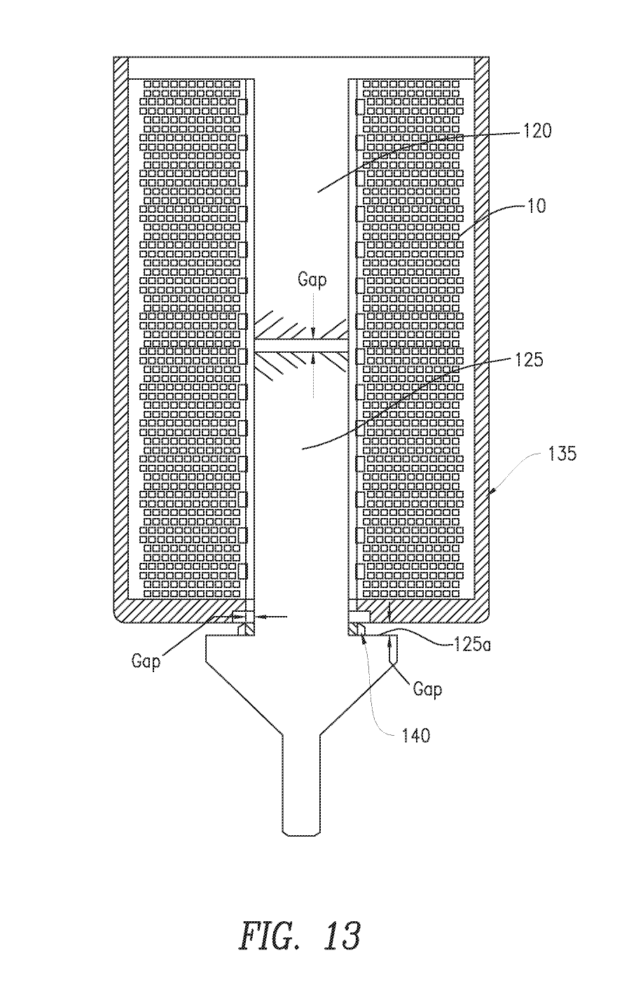

Now referring to FIGS. 12-12D, an atomizer system 500 including a solenoid 100 and valve 510 assembly is disclosed which may be mounted to a mounting panel 520 and connected in-line via conduit 530 with a fluid supply to produce an atomized spray of fluid upon actuation. One or more gaskets 580 may be employed to provide seals. A water swirler 550 may be positioned proximate the spray orifice 540. FIG. 12C shows the valve 510 in the open position. As shown in FIG. 12D the spray orifice 540 may be disposed to communicate with an environment to be humidified such as chamber 600, for example, an interior of a clothes dryer drum to impart humidity. Actuation of the solenoid 100 is operable to inject an atomized mist into the chamber 600.

With reference to FIGS. 12C and 12D, the solenoid pot 115 has disposed therein a solenoid core 120 and plunger 125 having flange 125a, and a spiral conductor coil 10 formed in accordance with one or more embodiments disclosed herein. The cross-sectional diameter of the cavity in which the spiral conductor coil 10 is formed, or the spiral conductor coil itself, may be any suitable diameter, such as described hereinabove. In one embodiment the cross-sectional diameter of the cavity or coil is about 0.003 inches, and the layers are each approximately 0.010 in thickness. The solenoid 100 may include encapsulate 130 which may be any suitable material known to the skilled artisan. A return spring 140 may be positioned between plunger flange 125a and magnetic circuit pot 135, the return spring acting as a shading ring.

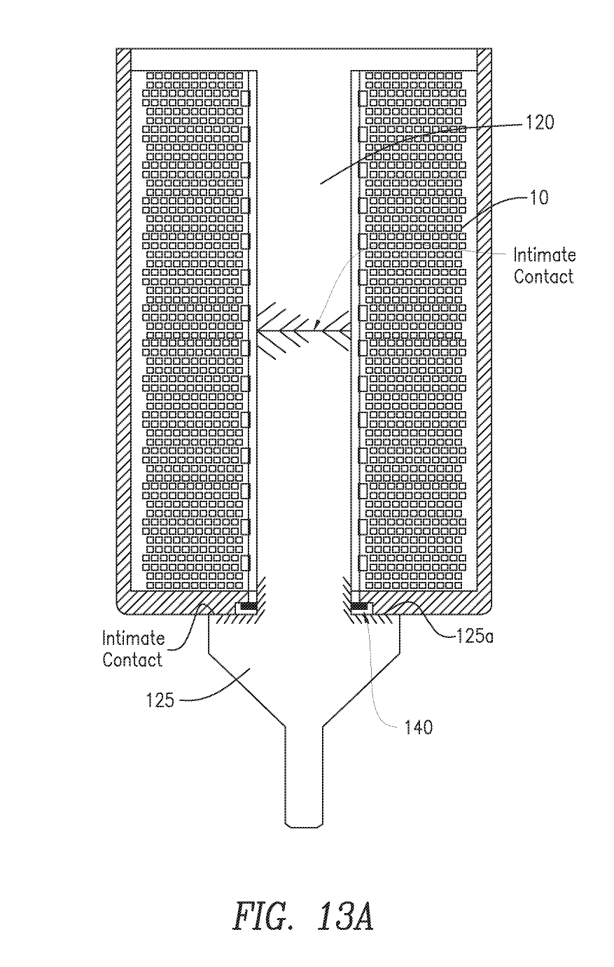

With further reference to FIGS. 13-13A, the solenoid may include a novel solenoid design with low operating temperature and quiet AC operation, with a novel shading ring arrangement.

In the prior art, a solenoid plunger moves within the coil and is part of the magnetic circuit. Also, in the prior art, the magnetic circuit could be made up, in addition to the plunger, of a core, which is also within the coil, and a magnetic conductive structure, which is outside of the coil. When in the de-energized plunger “out” position, there are two gaps: a gap between the core face and the plunger face, and a gap between the plunger and the outer magnetic conductive structure, which is clearance to allow movement. When air is added to the magnetic circuit, there is reduced total magnetic permeance, depending on the total air gap. When the permeance is low, as would be when there is a large air gap, the current necessary to operate and hold a solenoid's force is increased. Conversely, when the permeance is high, as would be when there is zero air gap, the current is reduced.

The plunger 125 shown in FIGS. 13-13A includes a flange, the effect of which is to remove all air gaps and obtain intimate contact between all elements of the magnetic circuit. This results in the solenoid having the lowest current requirement when the plunger is in the “in” holding position. This is useful when solenoids need to be energized for a lengthy time, in that it reduces the heat generated.

Also, solenoids which are operated with alternating current require a shading ring to keep the plunger from separating from the core during main coil zero flux moments. Otherwise, the solenoid will have an annoying and destructive vibration. The prior art locates this shading ring at the end of the core, at the juncture with the plunger face.

As shown in FIGS. 13-13A, the action of the return spring is combined with the action of the shading ring, thus performing both with one element. The shading ring is thus a dual acting part having the required resiliency to act as a spring, and the electrical conductivity to act as a shading ring. The solenoids of FIGS. 13-13A may include a spiral conductor coil 10 formed in accordance with one or more embodiments disclosed herein, or be employed in connection with prior art solenoids as an improvement.

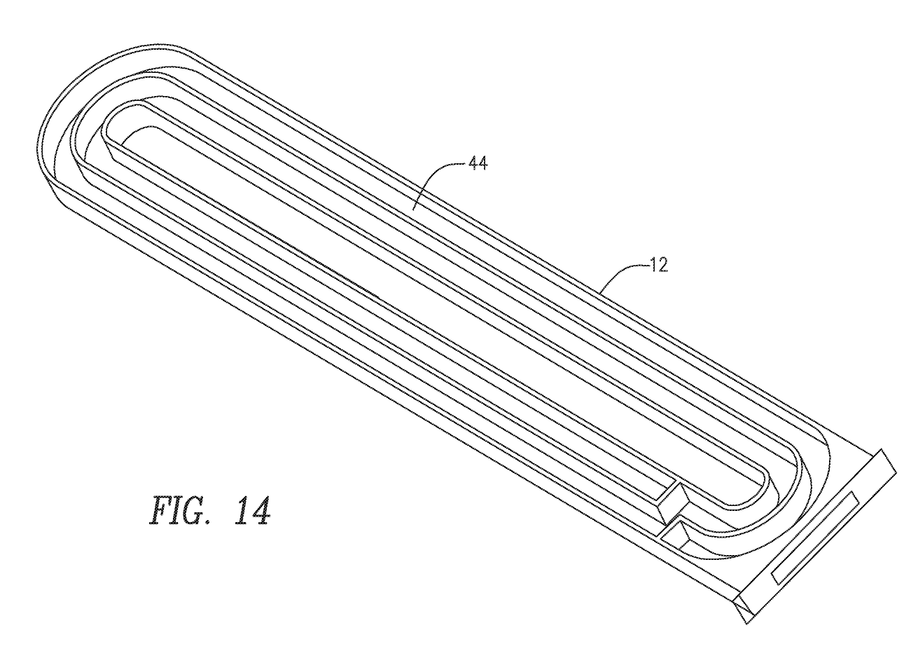

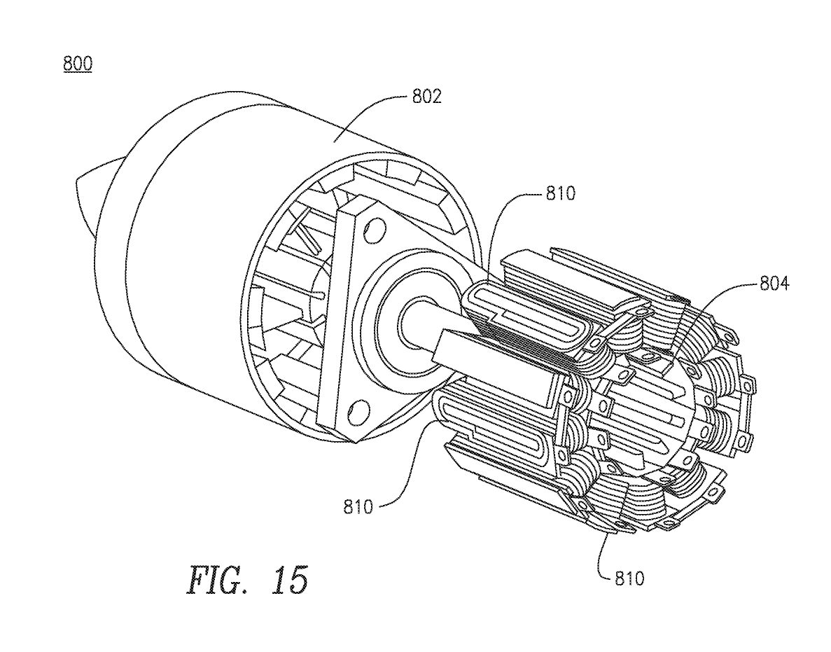

Now referring to FIG. 14, in one exemplary embodiments a rectangular insulation layer 12 is configured to receive conductor material in a spiral groove 44. With reference to FIG. 15, in an exemplary embodiment a motor 800 with stator 802 and rotor 804 includes oval spiral conductor coils 810.

Although the devices and systems of the present disclosure have been described with reference to exemplary embodiments thereof, the present disclosure is not limited thereby. Indeed, the exemplary embodiments are implementations of the disclosed systems and methods are provided for illustrative and non-limitative purposes. Changes, modifications, enhancements and/or refinements to the disclosed systems and methods may be made without departing from the spirit or scope of the present disclosure. Accordingly, such changes, modifications, enhancements and/or refinements are encompassed within the scope of the present invention.

What is claimed is:

1. A method of making a conductor coil which induces a magnetic field, the conductor coil comprising at least two spiral layers comprising conductive material and an air core, the method comprising constructing an insulation body comprising an internal cavity comprising a configuration corresponding to a configuration of the conductor coil and introducing conductive material into the insulation body.

2. The method according to claim 1 wherein the step of introducing conductive material into the insulation body forms a conductor coil comprising a first spiral layer comprising a first end terminating at an exterior periphery of the first spiral layer and extending spirally inward toward an inner portion of the first spiral layer terminating at a second end, a second spiral layer comprising a first end terminating at an interior periphery of the first spiral layer and extending spirally outward toward an exterior periphery of the first spiral layer, wherein the second spiral layer first end is conductively connected to the first spiral layer second end.

3. The method according to claim 1 wherein the step of constructing the insulation body comprising an internal cavity comprises printing the insulation body with an internal cavity using a three-dimensional printer.

4. The method according to claim 1 comprising forming plural layers of insulation material comprising spiral grooves, each of the grooves comprising at least one aperture formed therein, superimposing the plural layers such that the respective grooves of adjacent layers are configured to form a continuous cavity corresponding to the configuration of the conductor coil and the at least one aperture of each of the grooves is in communication with an a groove of an adjacent layer.

5. The method according to claim 1 comprising forming a spiral groove on a first insulation layer, the spiral groove comprising an aperture, filling the groove with a conductor material such that a first spiral layer is formed and a first bridge of conductive material is formed in the aperture, superimposing a further insulation layer comprising a spiral groove formed therein and an aperture formed in the groove, and filling the groove with a conductor material such that the conductive material forms a second spiral layer and a conductive connection with the first bridge and forms a second bridge that may be conductively connected to a subsequent spiral layer.

6. An insulation body comprising an internal cavity comprising a continuous cavity comprising at least two spiral layers wherein the first spiral layer has a configuration comprising a first end terminating at an exterior periphery of the first spiral layer and extending spirally inward toward an inner portion of the first spiral layer terminating at a second end, wherein the second spiral layer has a configuration comprising a first end terminating at an interior periphery of the first spiral layer and extending spirally outward toward an exterior periphery of the first spiral layer, wherein the second spiral layer first end is in open communication with the first spiral layer second end.

7. The insulation body according to claim 6 comprising a central bore.

8. The insulation body according to claim 7 comprising an aperture formed in a sidewall of the central bore.

9. A solenoid comprising an insulation body according to claim 6 and a conductor coil positioned in the continuous cavity.

10. An atomizer system comprising a solenoid according to claim 9 comprising a valve operably connected to the solenoid, wherein the valve is operably connectable to a fluid supply and a spray orifice.

11. A solenoid comprising a plunger comprising a flange configured and operable to remove air gaps and obtain intimate contact between elements of a magnetic circuit of the solenoid.

12. The solenoid according to claim 11 comprising a return spring operable to serve as a shading ring, wherein the return spring is positioned between the flange of the plunger and a magnetic circuit pot of the solenoid.
